(19) United States
(12) Patent Application Publication
(10) Pub. No.: US 2025/0172708 A1
(43) Pub. Date: May 29, 2025

(54) USE OF BACKGROUND RADIATION-BASED TOF OFFSETS TO EVALUATE ANNIHILATION RADIATION-BASED TOF OFFSETS

(71) Applicant: Siemens Medical Solutions USA, Inc., Malvern, PA (US)

(72) Inventors: Vladimir Panin, Knoxville, TN (US); Mehmet Aykac, Knoxville, TN (US); Deepak Bharkhada, Knoxville, TN (US)

(21) Appl. No.: 18/519,291

(22) Filed: Nov. 27, 2023

(51) Int. Cl. G01T 1/29; G01T 7/00

(52) U.S. Cl. CPC G01T 1/2985; G01T 1/2964; G01T 1/2992; G01T 7/005

(57) ABSTRACT

Systems and methods include determination of a first time-of-flight offset for each of a plurality of crystals based on first annihilation radiation received by the plurality of crystals, determination of a second time-of-flight offset for each of the plurality of crystals based on radiation emitted by the plurality of crystals, determination, based on the second time-of-flight offsets, of a third time-of-flight offset for each of the plurality of crystals and associated with a response of the plurality of crystals to annihilation radiation, determination of whether the third time-of-flight offsets exceed a threshold, and, in response to a determination that the third time-of-flight offsets exceed the threshold, determine a fourth time-of-flight offset for each of the plurality of crystals based on second annihilation radiation received by the plurality of crystals.

### BACKGROUND

According to conventional positron-emission-tomography (PET) imaging, a radiopharmaceutical tracer is introduced into a patient body via arterial injection. Radioactive decay of the tracer generates positrons which eventually encounter electrons and are annihilated thereby. The annihilation produces two 511 keV photons which travel in approximately opposite directions.

A ring of detectors surrounding the body detects photons, identifies “coincidences” based thereon, and reconstructs PET images based on the identified coincidences. A coincidence is identified when two detector crystals disposed on opposite sides of the body detect the arrival of two photons within a short time window indicating that the two photons arose from the same positron annihilation. Because the two “coincident” photons travel in approximately opposite directions, the locations of the two detector crystals determine a Line-of-Response (LOR) along which an annihilation may have occurred. Time-of-flight (TOF) PET additionally measures the difference between the detection times of the two photons arising from the annihilation. This difference may be used to estimate a particular position along the LOR at which the annihilation occurred. Coincidence detection and TOF measurements require extremely accurate and consistent determination of photon detection times.

Calibration is used to ensure consistency in photon detection times across the crystals of a PET scanner. According to conventional calibration, a known source of 511 keV photons is placed at a known position within a detector ring and PET data is acquired. Because the position of the source is known, the relative times at which coincident photons are expected to arrive at opposite crystals is also known. If the arrival times do not meet expectations, TOF offsets are determined per-crystal to ensure that the PET data is consistent with expectations. Typically, the determined TOF offsets are used to change hardware settings so that subsequently-acquired PET data reflects the determined TOF offsets and does not need to be TOF offset-corrected.

PET scanner response may change over time for many reasons. Accordingly, calibration is occasionally repeated to maintain consistency in photon detection times across the PET scanner. Calibration is a resource-consuming procedure and is therefore preferably performed only when needed. Systems are desired to efficiently determine whether system response has changed to a point at which recalibration of TOF offsets and/or TOF offset correction of PET data should be performed.

### BRIEF DESCRIPTION OF THE DRAWINGS

FIGS. 1A and 1B illustrate detection of coincidence events according to some embodiments.

FIG. 2 is a block diagram of a coincidence determination system according to some embodiments.

FIG. 3 is a flow diagram of a process to determine whether to re-calibrate TOF offsets of a PET scanner according to some embodiments.

FIG. 4 represents a TOF offset map generated based on annihilation radiation according to some embodiments.

FIG. 5 represents a TOF offset map generated based on background radiation according to some embodiments.

FIG. 6A is a block diagram illustrating estimation of an annihilation radiation TOF offset map based on a background radiation TOF offset map according to some embodiments.

FIG. 6B is a block diagram illustrating estimation of an annihilation radiation TOF offset map based on a background radiation TOF offset map according to some embodiments.

FIG. 7 illustrates training of a neural network to estimate an annihilation radiation TOF offset map based on a background radiation TOF offset map according to some embodiments.

FIG. 8 is a flow diagram of a process to acquire PET data and reconstruct an image based on the PET data according to some embodiments.

FIG. 9 is a block diagram of a PET-CT imaging system according to some embodiments.

### DETAILED DESCRIPTION

The following description is provided to enable any person in the art to make and use the described embodiments. Various modifications, however, will remain apparent to those in the art.

Generally, some embodiments estimate TOF offsets associated with annihilation radiation based on TOF offsets associated with background radiation emitted by detector crystals. Determination of TOF offsets associated with background radiation does not require a 511 keV photon source and may advantageously be performed during system downtime more quickly and efficiently than determination of annihilation radiation-based TOF offsets. Moreover, some embodiments use a trained machine learning model to quickly estimate the annihilation radiation-based TOF offsets. The estimated TOF offsets may then be used to determine whether re-calibration is advisable and/or to correct acquired PET data.

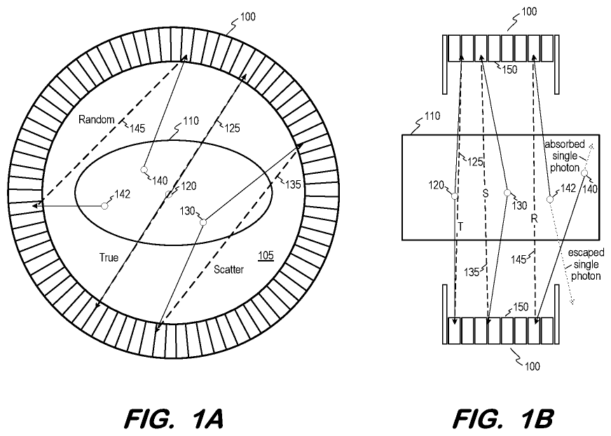

FIG. 1A and FIG. 1B illustrate detection of coincidences by a PET scanner according to some embodiments. FIG. 1A is a transaxial view of bore 105 of PET scanner detector ring 100 and imaging subject 110 disposed therein. Imaging subject 110 may comprise a human body, a phantom, or any other suitable subject. FIG. 1B is an axial view of detector ring 100 and body 110 of FIG. 1A. Detector ring 100 is composed of an arbitrary number (eight in this example) of adjacent and coaxial rings of detectors 150 in the illustrated example. Each detector 150 may comprise any number of detector crystals and electrical transducers.

The detector crystals may comprise lutetium oxyorthosilicate (LSO), lutetium-yttrium oxyorthosilicate (LYSO), or any other suitable materials that are or become known. The detector crystals characteristically emit radiation of lower energy than the 511 keV photons which result from positron annihilations. This crystal-emitted radiation is referred to herein as background radiation. The detector crystals create light photons in response to receiving 511 keV photons and in response to receiving the emitted background radiation. The electrical transducers, or photosensors, convert these light photons to electrical signals, sometimes referred to herein as pulses. According to some embodiments, the electrical transducers may comprise silicon photomultipliers (SiPMs) or photomultiplier tubes (PMTs).

Annihilations 120, 130, 140 and 142 are assumed to occur at various locations within subject 110. As described above, an injected tracer generates positrons which are annihilated by electrons to produce two 511 keV photons which travel in approximately opposite directions. Each of annihilations 120, 130, 140 and 142 results in the detection of a coincidence. True coincidences represent valid image data, while scatter and random coincidences represent noise associated with incorrect event position information.

A coincidence is detected when a pair of detector crystals receive two annihilation photons within a specified coincidence time window. Annihilation 120 is associated with a true coincidence because annihilation 120 resulted in two photons which were detected within the coincidence time window and because the position of annihilation 120 lies on LOR 125 connecting the positions of the crystals at which the two photons were received.

Annihilation 130 is associated with a scatter coincidence because, even though the two photons resulting from annihilation 130 were detected within the coincidence time window, the position of annihilation 130 does not lie on LOR 135 connecting the two photon positions. This may be due to Compton (i.e., inelastic) or Coherent (i.e., elastic) scatter resulting in a change of direction of at least one of the two annihilation photons within subject 110.

Annihilations 140 and 142 are two separate annihilations which result in detection of a random coincidence. In the present example, one of the photons generated by annihilation 140 is absorbed in body 210 and one of the photons generated by annihilation 142 escapes detection by any detector 150 of detector ring 100. The remaining two photons generated by the two annihilations happen to be detected within the coincidence time window, even though no annihilation occurred on LOR 145 connecting the positions at which the coincident photons were received.

The detected annihilations may be stored as raw (i.e., list-mode) data and/or sinograms. List-mode data may represent each annihilation using data specifying a LOR and the time at which the annihilation occurred. Since only the true unscattered coincidences indicate locations of annihilations, random coincidences and scatter coincidences are often subtracted from or otherwise used to correct acquired list-mode data or sinograms during reconstruction of a PET image based thereon.

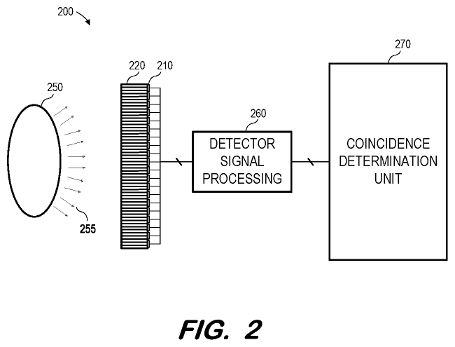

FIG. 2 illustrates PET detector ring portion 200 of a PET scanner according to some embodiments. Detector 200 ring portion includes transducers 210 and scintillator 220. Scintillator 220 may be pixelated (as shown), monolithic, or otherwise configured.

Detector ring portion 200 is positioned to detect gamma photons 255 emitted from volume 250. Systems for facilitating the emission of gamma photons from a volume are known in the art, and in particular with respect to the PET imaging described herein. As described above, crystals of scintillator 220 receive the gamma photons 255 and emit light photons in response. Transducers 210 receive the photons from scintillator 220 and each transducer 210 generates electrical signals based on the energy of photons it receives and its own characteristic photoelectric response profile.

Detector signal processing unit 260 receives the electrical signals generated by each of transducers 210 and performs signal processing to reject invalid pulses and to determine trigger times of valid pulses. The trigger time of a pulse is the time at which an annihilation photon which resulted in the pulse is considered to have reached a crystal of scintillator 220. Detector signal processing unit 260 may perform any suitable functions and exhibit any suitable implementations.

A TOF offset for each detector crystal may be determined during calibration as described above. The TOF offset for each crystal may be factored into a configuration of detector signal processing unit 260 such that the trigger times of pulses originating at a given crystal reflect the TOF offset determined for the given crystal.

Coincidence determination unit 270 receives all valid pulses, called singles, detected by each crystal of the detector ring and their corresponding trigger time. Coincidence determination unit 270 identifies a coincidence for each pair of valid pulses whose trigger times fall within a coincidence time window. In case detector signal processing unit 260 is not configured to produce trigger times which reflect the predetermined TOF offsets for each crystal, or if TOF offsets in addition to the predetermined TOF offsets are identified, coincidence determination unit 270 may apply TOF offsets to the trigger times on a crystal-specific basis prior to identifying coincidences.

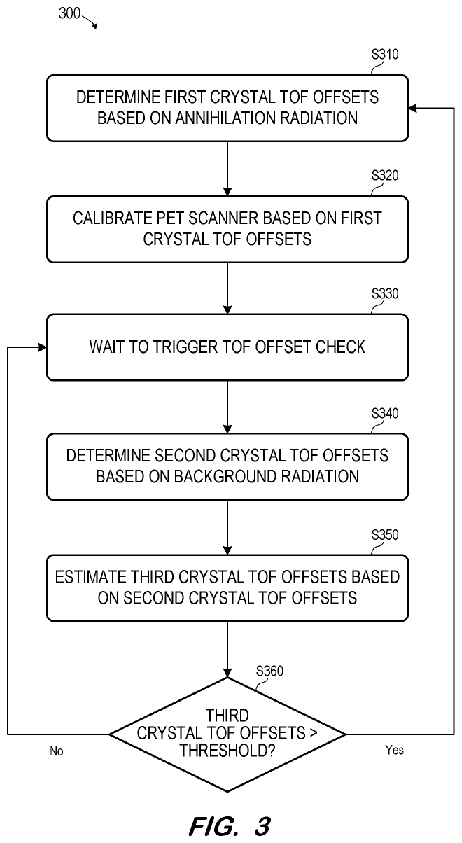

FIG. 3 is a flow diagram of process 300 to determine whether to re-calibrate TOF offsets of a PET scanner according to some embodiments. Process 300 may be performed by any combination of hardware and software that is or becomes known. Program code embodying these processes may be stored by any non-transitory tangible medium, including a fixed disk, a volatile or non-volatile random-access memory, a DVD, a Flash drive, and a magnetic tape, and executed by any suitable processing unit, including but not limited to one or more microprocessors, microcontrollers, processing cores, and processor threads. Embodiments are not limited to the examples described below.

TOF offsets for each of the crystals of a PET scanner are determined at S310 based on annihilation radiation. Determination of the TOF offsets may include injection of a radiopharmaceutical tracer into a volume and subsequent acquisition of PET data by a static PET scan as is known in the art. The volume may comprise a phantom such as, for example, a uniform water-filled cylinder, but may also comprise a patient. The radiopharmaceutical tracer may comprise any suitable tracer, such as but not limited to FDG.

The PET data may comprise raw (i.e., list-mode) data and/or sinograms. List-mode data may represent each detected coincidence by an LOR between two crystals, the time at which each photon of the annihilation reached each crystal and the difference between the arrival times of the two photons. A sinogram is a data array of the angle versus the displacement of each LOR. A sinogram includes one row containing the LOR for a particular azimuthal angle (p. Each of these rows corresponds to a one-dimensional parallel projection of the tracer distribution at a different coordinate. A sinogram stores the location of the LOR of each coincidence such that all the LORs passing through a single point in the volume trace a sinusoid curve in the sinogram.

Since the location and geometry of the volume is known, it is possible to determine target PET data which would be acquired if the trigger times associated with each crystal were consistent throughout the PET scanner. S310 may therefore include determination of the per-crystal TOF offsets which, if applied to the acquired PET data, would result in PET data that is substantially similar to the target PET data. In some embodiments, a target image of the volume is reconstructed based on the acquired PET data using non-TOF reconstruction, and per-crystal TOF offsets are determined which could be applied to the acquired PET data to generate modified PET data, where an image reconstructed from the modified PET data would be substantially similar to the target image.

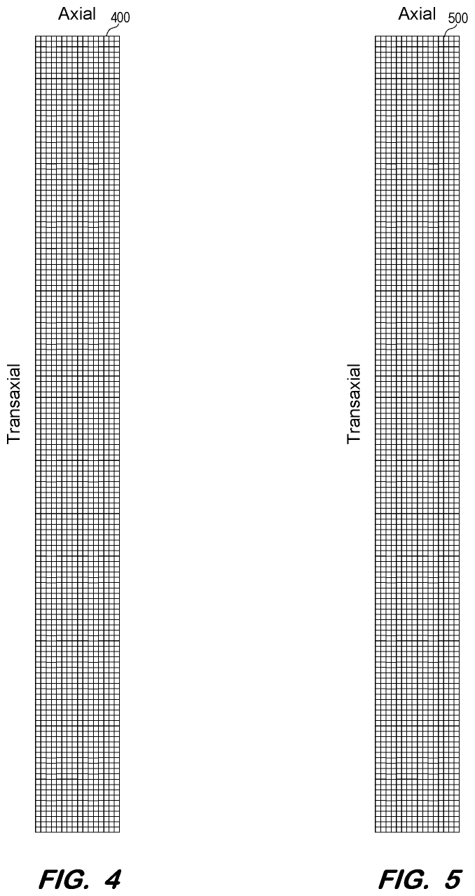

FIG. 4 represents TOF offset map 400 generated based on annihilation radiation according to some embodiments. Specifically, map 400 presents the ring-like detector configuration depicted in FIG. 1A in an “unrolled” manner. Map 400 represents the crystals of eight detectors in the axial direction and thirty-eight detectors in the transaxial direction. Each detector includes two hundred crystals, with rows of ten crystals in the axial direction and twenty crystals in the transaxial direction. As such, map 400 includes 60,800 detector crystals, with rows of eighty detector crystals in the axial direction and rows of seven hundred sixty detector crystals in the transaxial direction.

Map 400 depicts a TOF offset for each crystal of a PET scanner. Map 400 may be considered an image, in which each crystal is a pixel with a distinct (x, y) position and the value of a pixel is the TOF offset determined for the crystal represented by the pixel. The data of map 400 may be stored in any suitable manner.

Next, at S320, the PET scanner is calibrated based on the crystal TOF offsets determined at S310. S320 may comprise any system to perform such calibration that is or becomes known. For example, the detection hardware of the PET scanner may be configured such that the trigger times of each pulse originating from a given detector crystal incorporate the TOF offset determined for the given detector crystal. A determination of TOF offsets performed immediately after such configuration should ideally result in a TOF offset of 0.0 for each detector crystal.

Some embodiments may omit S320 by alternatively incorporating TOF offsets into the determination of coincidences. For example, such embodiments may apply the TOF offset of a given crystal to the trigger times of pulses associated with the given crystal prior to coincidence determination.

Flow pauses at S330 until a TOF offset check is triggered. Any one or more suitable events may trigger a TOF offset check in some embodiments. A TOF offset check may be triggered once or more per day at specified times, immediately prior to a patient scan, immediately after a patient scan, upon detection of an error, and/or for any other reason. Triggering of the TOF offset check may include triggering of one or more other quality control checks. Flow proceeds to S340 once a TOF offset check is triggered.

At S340, second TOF offsets are determined based on background radiation. The naturally-occurring lutetium in LSO and LYSO crystals includes Lu-176. When Lu-176 decays, one beta particle and three gamma photons are emitted in coincidence. The gamma photons have energies of 88, 202, and 307 keV.

Considering the case of a single decay, a beta particle is emitted at crystal A and this beta emission may be detected at crystal A based on an energy window corresponding to the known energy of the beta particle. When a gamma photon emitted in coincidence with the beta particle traverses a linear path L and strikes another crystal B, that strike can similarly be detected based on a suitable energy window. The energy window for detection of background gamma photons may encompass 202 and 307 keV gamma photons but the 88 keV gamma photons are generally too low in energy to be detected. If the timing of the detections at crystals A and B is within a suitable coincidence window, the detections can be correlated to the same Lu-176 decay.

An expected TOF between crystals A and B is determined based on the known distance between crystals A and B and the known speed of a gamma photon emitted by decay of Lu-176 is known. The difference between the expected TOF and the measured TOF (i.e., the time elapsed between the detection of the beta particle at crystal A and the detection of the gamma photon at crystal B) should be zero or nearly zero. Background radiation TOF offsets are determined for each crystal of the PET scanner such that, if applied to the detection times of the crystals and used to recalculate the measured TOFs, would result in all the measured TOFs being substantially equal to their corresponding expected TOFs.

FIG. 5 represents TOF offset map 500 generated based on background radiation according to some embodiments. Map 500 depicts a TOF offset determined for each crystal of a PET scanner based on background radiation. Each pixel of map 500 represents a crystal and has a value equal to the TOF offset determined for the represented crystal.

At S350, third crystal TOF offsets are estimated based on the second crystal TOF offsets determined at S340. Although the second crystal TOF offsets represent system response to background radiation, the estimated third crystal TOF offsets are intended represent system response to annihilation radiation (i.e., 511 keV photons).

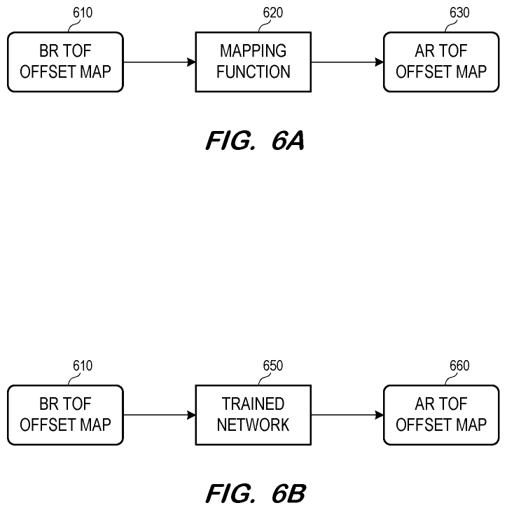

FIG. 6A is a block diagram illustrating estimation of an annihilation radiation TOF offset map based on a background radiation TOF offset map according to some embodiments. Background radiation offset map 610 specifies a TOF offset for each crystal in a PET scanner determined based on background radiation. Background radiation offset map 610 may comprise map 500 according to some embodiments. Background radiation offset map 610 is input to mapping function 620, which maps the TOF offset specified for each crystal by map 610 to other TOF offsets. The resulting TOF offsets may be represented by annihilation radiation TOF offset map 630.

Mapping function 620 may comprise any suitable function. Mapping function 620 may be determined using data-driven techniques, such as modelling physical characteristics of the PET scanner and/or determining a mathematical transformation between background radiation TOF offset maps and annihilation radiation TOF offset maps. The latter transformation may be determined based on sample sets of background radiation TOF offset maps and corresponding (e.g., contemporaneously or simultaneously determined) annihilation radiation TOF offset maps.

Determination of a mapping function such as mapping function 620 and its use at S350 may be unduly consumptive of time and/or computing resources. FIG. 6B is a block diagram illustrating estimation of annihilation radiation TOF offset map 660 based on background radiation TOF offset map 610 and trained neural network 650 according to some embodiments. Trained neural network 650 may comprise any network suitable to receive three-dimensional data (e.g., (x, y, TOF offset)) and to output three-dimensional data. Since the TOF offset maps described herein may be considered images where each pixel is specified by dimensions x, y and TOF offset, trained neural network 650 may comprise a network suitable for image generation, such as but not limited to a convolutional-deconvolutional network.

Network 650 may comprise any type of iterative learning-compatible network, algorithm, decision tree, etc., that is or becomes known. Network 650 may comprise a plurality of layers of neurons which receive input, change internal state according to that input, and produce output depending on the input and internal state. The output of certain neurons is connected to the input of other neurons to form a directed and weighted graph. The weights as well as the functions that compute the internal states are iteratively modified during training using supervised learning algorithms. Trained network 650 may be implemented by a set of linear equations, executable program code, a set of hyperparameters defining a model structure and a set of corresponding weights, or any other representation of the mapping of input to output which was learned as a result of the training.

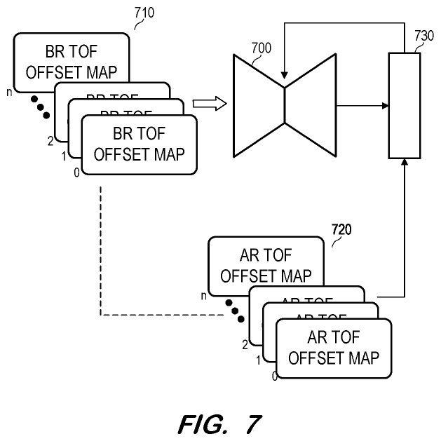

FIG. 7 illustrates training of neural network 700 to estimate an annihilation radiation TOF offset map based on a background radiation TOF offset map according to some embodiments. Training data consists of N background radiation TOF offset maps 710 and corresponding N annihilation radiation TOF offset maps 720. Specifically, each of N annihilation radiation TOF offset maps 720 comprises the ground truth data for a corresponding one of background radiation TOF offset maps 710. Maps 710 and 720 may be obtained from any number of repositories maintained by any number of sources.

Each background radiation TOF offset map 710 and its corresponding ground truth TOF offset map 720 may be determined in any manner that is or becomes known. In one example, an annihilation radiation TOF offset map 720 is determined as described above with respect to S310 and a corresponding background radiation TOF offset map 710 is determined shortly thereafter as described with respect to S340. A background radiation TOF offset map 710 may be determined shortly before its corresponding annihilation radiation TOF offset map 720 in some embodiments.

According to some embodiments, a background radiation TOF offset map 710 and its corresponding annihilation radiation TOF offset map 720 are determined simultaneously. For example, a PET scanner may be configured to detect photons over a wide energy window including 202, 307 and 511 keV. 511 keV photon detections are used to determine an annihilation radiation TOF offset map while 202 and 307 keV photon detections are used to determine a corresponding background radiation TOF offset map. Since the maps are determined while a same object is in a same position within the bore of the PET scanner, simultaneous determination of the two maps reduces errors which might otherwise be caused by attenuation differences within the bore during acquisition of the PET data used to determine each map.

During training, a batch of background radiation TOF offset maps 710 is input to network 700, which outputs an annihilation radiation TOF offset map (not shown) for each input map of the batch. Loss layer 730 calculates a loss based on differences between each output annihilation radiation TOF offset map and its corresponding ground truth annihilation radiation TOF offset map 720. The loss is back-propagated to network 700, which is modified with the aim of minimizing the loss as is known in the art. Training continues in this manner until satisfaction of a given performance target or a timeout situation. After training, network 700 may be deployed as shown in FIG. 6B to infer estimate an annihilation radiation TOF offset map based on an input background radiation TOF offset map.

Returning to process 300, it is determined at S360 if the third crystal TOF offsets determined at S350 exceed a threshold. The threshold may be a value or values which indicate that the annihilation radiation TOF offsets of the PET scanner have changed to an unacceptable degree. In some embodiments, the third crystal TOF offsets are expected to be substantially zero because the PET scanner was calibrated at S320 based on the first crystal TOF offsets determined at S310. Accordingly, the threshold may be a maximum TOF offset for any given crystal, a maximum sum of the absolute values of all the TOF offsets estimated at S350, or any other suitable threshold.

In some embodiments, the PET scanner is not calibrated based on the first crystal TOF offsets but the first crystal TOF offsets are accounted for during coincidence determination. Accordingly, the threshold at S360 may be a maximum difference in the first TOF offset and the third TOF offset for any given crystal, a maximum sum of the absolute values of differences between the first TOF offset and the third TOF offset for all crystals, or any other suitable threshold.

Flow returns to S330 to await triggering of a next TOF offset check if it is determined at S360 that the third crystal TOF offsets do not exceed a threshold. Flow may cycle between S330 and S360 in this manner while the PET scanner continues to acquire PET data of patients and reconstruct PET images therefrom until it is determined at S360 that the third crystal TOF offsets exceed the threshold. In response, flow returns to S310 to re-determine crystal TOF offsets based on annihilation radiation and to re-calibrate the PET scanner based thereon at S320.

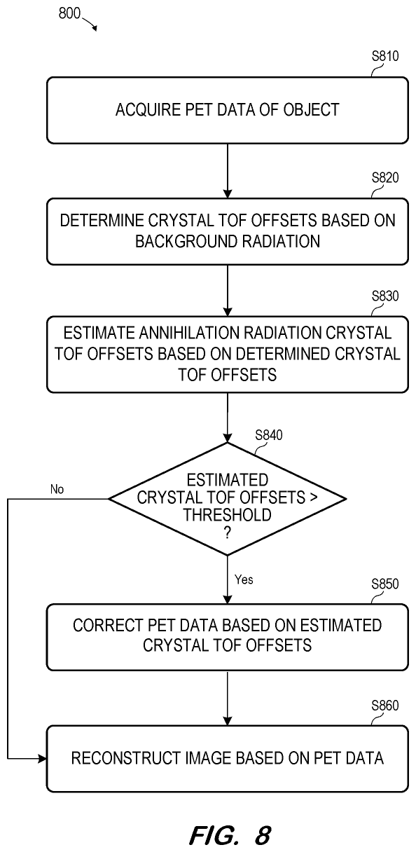

FIG. 8 is a flow diagram of a process to acquire PET data and reconstruct an image based on the PET data according to some embodiments. Initially, PET data is acquired at S810 by injecting a radiopharmaceutical into an object and detecting 511 keV photons emitted from the object using a PET scanner. The object may comprise a human body in some embodiments. As described above, the acquired PET data may comprise TOF list-mode data or a TOF sinogram.

Crystal TOF offsets are determined at S820 based on background radiation emitted from the detector crystals of the PET scanner. As described above, S820 includes detection of emitted beta particles and 202, 307 keV gamma photons. The detections at S820 may occur after removal of the object from the PET scanner (i.e., while no object is located within the bore of the PET scanner) or during the acquisition of PET data at S810.

Next, annihilation radiation crystal TOF offsets are estimated based on the TOF offsets determined at S820. The annihilation radiation crystal TOF offsets may be estimated in some embodiments by inputting the determined TOF offsets to a neural network trained as described above.

At S840, it determined if the estimated crystal TOF offsets exceed a threshold. The threshold may be a value or values which indicate that the annihilation radiation TOF offsets of the PET scanner have changed to an unacceptable degree. In some embodiments, the annihilation radiation crystal TOF offsets are expected to be substantially zero at S840 due to prior calibration, and the threshold is a measure representing an unacceptable deviation from this expectation. The threshold may be a maximum TOF offset for any given crystal, a maximum sum of the absolute values of all the estimated TOF offsets, or any other suitable threshold.

If the estimated crystal TOF offsets do not exceed the threshold, an image is reconstructed based on the acquired PET data at S860. If the threshold is exceeded, the PET data is corrected at S850 based on the estimated crystal TOF offsets. For example, the estimated crystal TOF offsets are applied to the photon arrival times associated with each crystal (in addition to any TOF offset which was already applied to the arrival times) and coincidences are determined based on the updates arrival times. An image is then reconstructed based on the corrected PET data at S860.

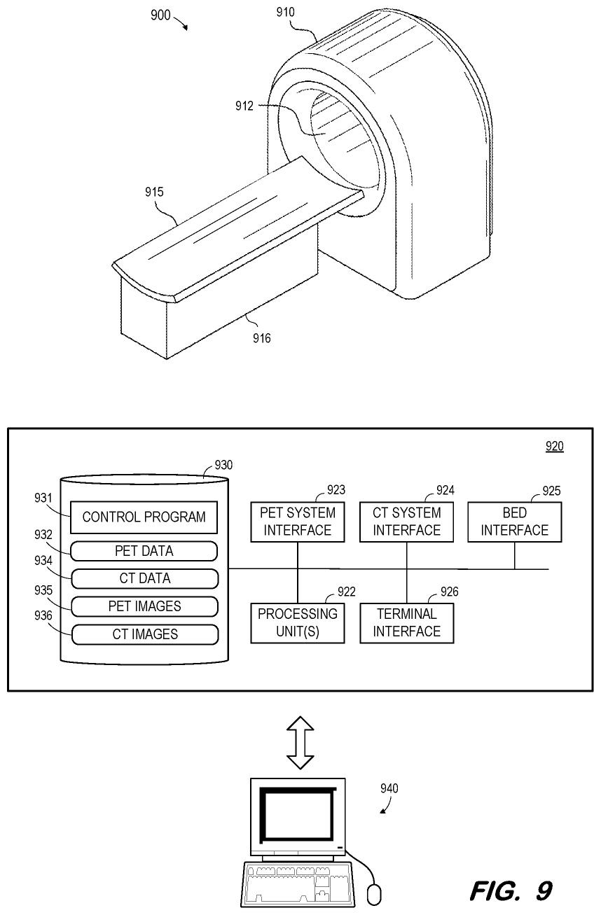

FIG. 9 illustrates PET/Computed Tomography (CT) imaging system 900 to execute one or more of the processes described herein. Embodiments are not limited to system 900, to a multi-modality imaging system, or to an imaging system.

System 900 includes gantry 910 defining bore 912. As is known in the art, gantry 910 houses PET imaging components for acquiring PET image data and CT imaging components for acquiring CT image data. The CT imaging components may include one or more x-ray tubes and one or more corresponding x-ray detectors as is known in the art. The PET imaging components may include any number or type of detectors including background radiation-emitting crystals and disposed in any configuration as is known in the art.

Bed 915 and base 916 are operable to move a patient lying on bed 915 into and out of bore 912 before, during and after imaging. In some embodiments, bed 915 is configured to translate over base 916 and, in other embodiments, base 916 is movable along with or alternatively from bed 915.

Movement of a patient into and out of bore 912 may allow scanning of the patient using the CT imaging elements and the PET imaging elements of gantry 910. Bed 915 and base 916 may provide continuous bed motion and/or step-and-shoot motion during such scanning according to some embodiments.

Control system 920 may comprise any general-purpose or dedicated computing system. Accordingly, control system 920 includes one or more processing units 922 configured to execute processor-executable program code to cause system 920 to acquire image data and generate images therefrom, and storage device 930 for storing the program code. Storage device 930 may comprise one or more fixed disks, solid-state random-access memory, and/or removable media (e.g., a thumb drive) mounted in a corresponding interface (e.g., a Universal Serial Bus port).

Storage device 930 stores program code of control program 931. One or more processing units 922 may execute control program 931 to, in conjunction with PET system interface 923 and bed interface 925, control hardware elements to inject a radiopharmaceutical into a patient, move the patient into bore 912 past PET detectors of gantry 910, and detect photons emitted from the patient based on pulses generated by the PET detectors. The detected photons may be recorded in storage 930 as PET data 932, which may comprise raw (i.e., list-mode) data and/or sinograms.

Control program 931 may be executed to determine TOF offsets based on crystal-emitted background radiation and estimate annihilation radiation TOF offsets using the determined TOF offsets and a trained neural network. Control program 931 may also be executed to reconstruct PET images 935 based on PET data 932 using any suitable reconstruction algorithm that is or becomes known.

One or more processing units 922 may execute control program 931 to control CT imaging elements of system 900 using CT system interface 924 and bed interface 925 to acquire CT data 934. Any suitable reconstruction algorithm may be utilized to generate CT images 936 based on CT data 934. According to some embodiments, PET images 935 may be generated based at least in part on CT data 934 (e.g., using a linear attenuation coefficient map determined from CT data 934).

PET images 935 and CT images 936 may be transmitted to terminal 940 via terminal interface 926. Terminal 940 may comprise a display device and an input device coupled to system 920. Terminal 940 may display the received PET images 935 and CT images 936. Terminal 940 may receive user input for controlling display of the data, operation of system 900, and/or the processing described herein. In some embodiments, terminal 940 is a separate computing device such as, but not limited to, a desktop computer, a laptop computer, a tablet computer, and a smartphone.

Each component of system 900 may include other elements which are necessary for the operation thereof, as well as additional elements for providing functions other than those described herein. Each functional component described herein may be implemented in computer hardware, in program code and/or in one or more computing systems executing such program code as is known in the art. Such a computing system may include one or more processing units which execute processor-executable program code stored in a memory system.

Those in the art will appreciate that various adaptations and modifications of the above-described embodiments can be configured without departing from the claims. Therefore, it is to be understood that the claims may be practiced other than as specifically described herein.

What is claimed is:

1. A positron emission tomography (PET) scanner system comprising:
a plurality of detector crystals; and
a processing unit to:
determine a first time-of-flight offset for each of the plurality of crystals based on first annihilation radiation received by the plurality of crystals;
determine a second time-of-flight offset for each of the plurality of crystals based on radiation emitted by the plurality of crystals;
determine, based on the second time-of-flight offsets, a third time-of-flight offset for each of the plurality of crystals and associated with a response of the plurality of crystals to annihilation radiation;
determine whether the third time-of-flight offsets exceed a threshold; and
in response to a determination that the third time-of-flight offsets exceed the threshold, determine a fourth time-of-flight offset for each of the plurality of crystals based on second annihilation radiation received by the plurality of crystals.

2. The system of claim 1, wherein determination of whether the third time-of-flight offsets exceed a threshold comprises determination of whether a difference between the first time-of-flight offsets and the third time-of-flight offsets exceed the threshold.

3. The system of claim 1, the processing unit to:
calibrate the system based on the first time-of-flight offsets; and
calibrate the system based on the fourth time-of-flight offsets.

4. The system of claim 3, wherein determination of the third time-of-flight offsets comprises input of the second time-of-flight offsets to a trained neural network.

5. The system of claim 4, wherein the trained neural network is a convolutional/deconvolutional neural network.

6. A method comprising:
acquiring positron emission tomography (PET) data based on annihilation radiation emitted from an object and received by a plurality of detector crystals of a PET scanner;
determining a first time-of-flight offset for each of the plurality of detector crystals based on radiation emitted by the plurality of crystals;
determining, based on the first time-of-flight offsets, a second time-of-flight offset for each of the plurality of crystals;
determining whether the second time-of-flight offsets exceed a threshold;
in response to a determination that the second time-of-flight offsets exceed the threshold, correcting the PET data based on the second time-of-flight offsets; and
reconstructing an image based on the corrected PET data.

7. The method of claim 6, wherein determining whether the second time-of-flight offsets exceeds a threshold comprises determining whether a difference between the second time-of-flight offsets and third time-of-flight offsets exceed the threshold,
wherein the third time-of-flight offsets comprise a third time-of-flight offset for each of the plurality of detector crystals determined based on calibration annihilation radiation received by the plurality of crystals during a calibration process.

8. The method of claim 6, further comprising:
calibrating the PET scanner based on the second time-of-flight offsets.

9. The method of claim 6, wherein determining the second time-of-flight offsets comprises inputting the first time-of-flight offsets to a trained neural network.

10. The method of claim 9, wherein the trained neural network is a convolutional/deconvolutional neural network.

11. The method of claim 6, wherein the annihilation radiation is received by the plurality of crystals and the radiation is emitted by the plurality of crystals substantially simultaneously.

12. The method of claim 11, wherein determining the second time-of-flight offsets comprises inputting the first time-of-flight offsets to a trained neural network.

13. A non-transitory medium storing program code, the program code executable by at least one processing unit to cause a computing system to:
acquire positron emission tomography (PET) data based on annihilation radiation emitted from an object and received by a plurality of detector crystals of a PET scanner;
determine a first time-of-flight offset for each of the plurality of detector crystals based on radiation emitted by the plurality of crystals;
determine, based on the first time-of-flight offsets and a trained neural network, a second time-of-flight offset for each of the plurality of crystals;
determine that the second time-of-flight offsets exceed a threshold;
in response to the determination that the second time-of-flight offsets exceed the threshold, correct the PET data based on the second time-of-flight offsets; and
reconstruct an image based on the corrected PET data.

14. The medium of claim 13, wherein determination of whether the second time-of-flight offsets exceeds a threshold comprises determination of whether a difference between the second time-of-flight offsets and third time-of-flight offsets exceed the threshold,
wherein the third time-of-flight offsets comprise a third time-of-flight offset for each of the plurality of detector crystals determined based on calibration annihilation radiation received by the plurality of crystals during a calibration process.

15. The medium of claim 13, the program code executable by at least one processing unit to cause a computing system to:
calibrate the PET scanner based on the second time-of-flight offsets.

16. The medium of claim 13, wherein the annihilation radiation is received by the plurality of crystals and the radiation is emitted by the plurality of crystals substantially simultaneously.
